(19) United States
(12) Patent Application Publication
(10) Pub. No.: US 2021/0129565 A1
(43) Pub. Date: May 6, 2021

(54) Printing Device and Machine for Building Material Articles

(71) Applicants: SCG BUILDING MATERIALS CO., LTD., BANGKOK (TH); SCG CERAMICS PUBLIC CO., LTD., BANGKOK (TH)

(72) Inventors: Watthanakun PHABUTTA, BANGKOK (TH); Somchai PIMPRASAN, BANGKOK (TH); Terdwong JAMRUSSAMEE, BANGKOK (TH); Thitipong MUANGSRI, BANGKOK (TH)

(21) Appl. No.: 16/474,840

(22) PCT Filed: Dec. 27, 2017
(86) PCT No.: PCT/IB2017/058428

§ 371 Date: Jun. 28, 2019

(30) Foreign Application Priority Data
Dec. 28, 2016 (IT) 102016000131820

(51) Int. Cl. B41M 5/00; B28B 11/04; B41M 1/34

(52) U.S. Cl. CPC B41M 5/007; B41M 1/34; B28B 11/048

(57) ABSTRACT

A printing device for building material articles, comprises a tank (2) for a printing material, solid or liquid, to be dispensed, an outlet mouth (3) suitable for dispensing the printing material onto a work surface, a conduit (5) extending along its own main direction (A) between the tank (2) and the outlet mouth (3), in which the conduit (5) comprises at least one deformable wall (6) movable between an operating position, in which it determines the creation of a restriction in the conduit (5) preventing the flow of the printing material towards the outlet mouth (3), and a rest position, in which it allows the flow of the printing material towards the outlet mouth (3).

The present invention relates to a printing device (or head) and machine for building material articles, preferably, but not exclusively, for tiles or ceramic slabs, in particular for screen-printing or printing with high volume enamels or inconsistent powder material.

Therefore, the present invention finds particular application in the building industry and, in particular, in enameling and coloring (screen-printing for example) ceramic slabs, concrete surfaces etc. . . .

Numerous solutions are known in the prior art for printing devices, which are mainly subdivided into piezoelectric printing heads and electromagnetic actuation printing heads.

Piezoelectric printing heads generally comprise a plurality of piezoelectric valves arranged in series, each defining a nozzle for releasing an enamel. In particular, each valve comprises the use of a deformable crystal, which, after excitement with varying voltage based on a driving signal, allows the passage of a predetermined quantity of enamel.

One example of such solution is known from the device Xaar 001, by the company Xaar®, which presents a box-like body having an operating face from which a plurality of nozzles are faced, arranged in series on a row. Such nozzles are all defined by piezoelectric actuators, each associated with a separate enamel tank.

Disadvantageously, as stated previously, such device can only be used for the ejection and distribution of enamels with low/medium volumes, in which the particles have dimensions (i.e. diameter) much lower than a hundredth of a millimeter (in the order of microns or of tens of microns). The reason for such constraint lies mainly in the limited movement allowed by the piezoelectric actuation, in which the excitement of the shutter produces a movement with strokes in the order of microns.

Consequently, this is extremely limiting for producers who are forced to choose products from a narrow range of solutions, which leads to the production of solutions, which are increasingly uniform between each other.

However, electromagnetic actuation systems are also not without drawbacks.

In fact, despite also allowing high volume enamels to be dispensed, electromagnetic actuators also have dimensional constraints, which cannot be ignored.

Moreover—and this applies both to the piezoelectric heads and to the electromagnetic ones—all of the devices of the prior art have a metal shutter, which has a contact surface with the nozzle transverse to the direction of the flow, which, due to the considerable hardness of the solid particles in the printing enamels, significantly increases the level of wear and tear of the device.

Furthermore, we must not forget that the presence of solid particles in the enamels includes the risk of incomplete valve closure, with a consequent reduction in the quality of the printing.

For this reason, too, the particles are refined as much as possible today, with a considerable expenditure of energy and money for producers.

It is the object of the present invention to provide a printing device and machine for building material articles, which overcomes the drawbacks of the prior art described above.

In particular, it is an object of the present invention to provide a printing device and machine for building material articles with an increased useful life and which is easy to maintain.

Furthermore, it is an object of the present invention to provide a printing device for building material articles, which allows the quality of the printing to be maximized, also using coarse printing materials or enamels.

Said objects are achieved with a printing device presenting the features of one or more of the following claims 1 to 20, and a printing machine presenting the features in claim 21.

In particular, the intended objects are achieved with a printing device for building material articles, comprising a tank for a printing material, solid or liquid, to be dispensed, an outlet mouth suitable for dispensing the printing material onto a working surface, a conduit extending along its own main direction between said tank and outlet mouth, to transfer the printing material from the tank to said outlet mouth.

According to one aspect of the present invention, the conduit comprises at least one deformable wall movable between an operating position, in which it determines the creation of a restriction in the conduit, preventing the flow of the printing material towards the outlet mouth, and a rest position, in which it allows the flow of the printing material towards the outlet mouth.

In this respect, a movement unit is preferably comprised, arranged outside said conduit and associated with said deformable wall, to move it between the operating position and the rest position.

Advantageously, the presence of a deformable wall along the conduit means that the occluding action performed by the same is mostly tangential to the flow of the material, with a significant reduction in the impact with the material particles and greater ease in obtaining complete closure of the conduit.

Furthermore, the deformable wall is preferably made of an elastically deformable material, more preferably rubber.

This is particularly advantageous, both in terms of performance and durability.

In fact, the deformability of the wall, in particular of the rubber, guarantees the occlusion of the conduit, also in the presence of particles of material interposed in the area of the restriction.

Furthermore, the “radial” action (with respect to the main direction of the conduit) of the wall combined with its deformability means that even if it is worn, therefore without some layers of material, the wall is nonetheless perfectly efficient.

Furthermore, note that, inside, the tank preferably presents a predetermined first pressure, while the movement unit is configured to generate a second pressure on the deformable wall, outside the conduit. The printing device also comprises a control unit configured to drive at least one of said first and second pressure (preferably the second) for selectively moving the deformable wall between the operating position, in which the second pressure is higher than the first pressure, and the rest position, in which the second pressure is lower than the first pressure. Advantageously, the pressure drive, therefore by means of a pushing member or operating fluid, removes the current and electrical driving components from the fluid passage area, with considerable benefits in terms of reliability.

Preferably, the device also comprises a blowing unit placed at said outlet mouth, externally thereto, to clean it from possible residues of printing material.

Advantageously, this ensures that the printing head is kept clean and functional also after long working sessions.

Also note that the printing device according to the present invention can be used for dispensing both enamels, in other words liquids containing solid particles and solid inconsistent printing materials.

In the first case, the tank preferably comprises pressure generating means configured to dispense the fluid printing material into the conduit, in this case, at the predetermined first pressure.

Furthermore, the tank preferably comprises a compensation member configured to keep the pressure in the tank equal to said predetermined first pressure when the deformable wall of the conduit is in said operating position.

Advantageously, in this way, the pressure in the tank is controlled and does not undergo variations also after “closure” of the conduit, allowing the device to be kept at maximum efficiency.

These and other advantages will become more apparent from the following example, given by way of example and therefore not limiting, of a preferred embodiment, which is thus not exclusive, of a printing device and machine for tiles or ceramic slabs as illustrated in the following drawing tables, wherein:

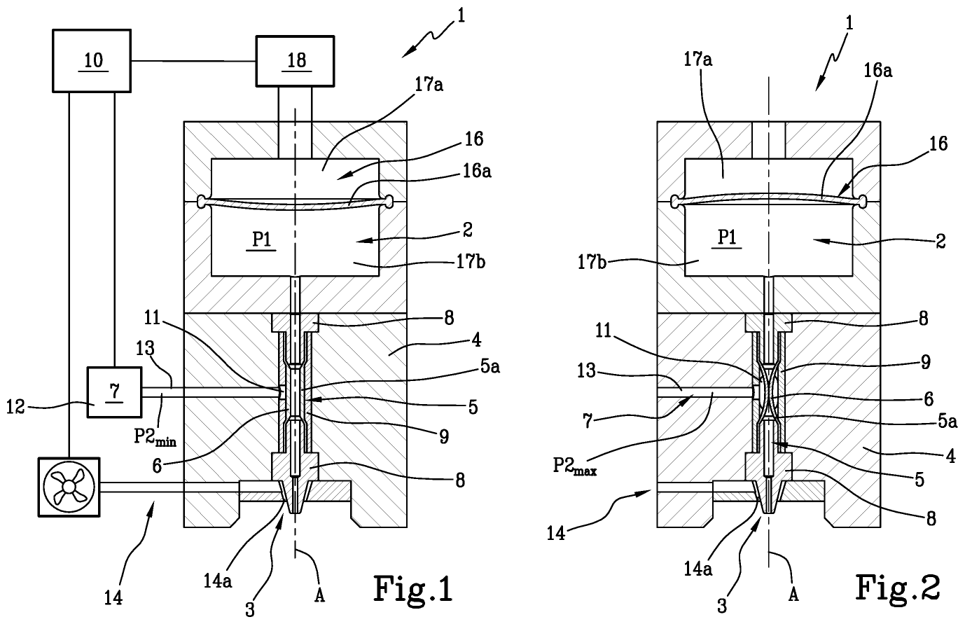

FIGS. 1 and 2 show a first embodiment of a printing device for building material articles according to the present invention, in two different operating states;

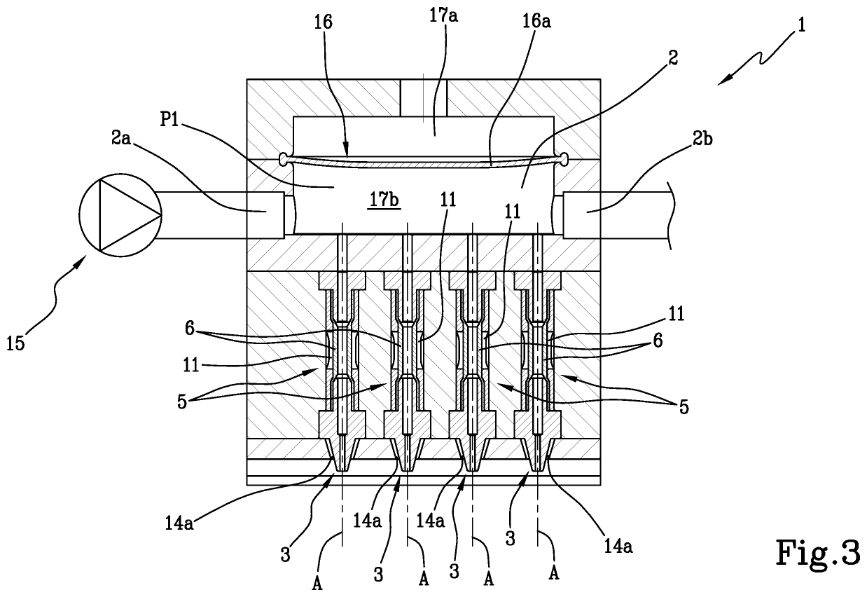

FIG. 3 shows a variation of the device in FIG. 1;

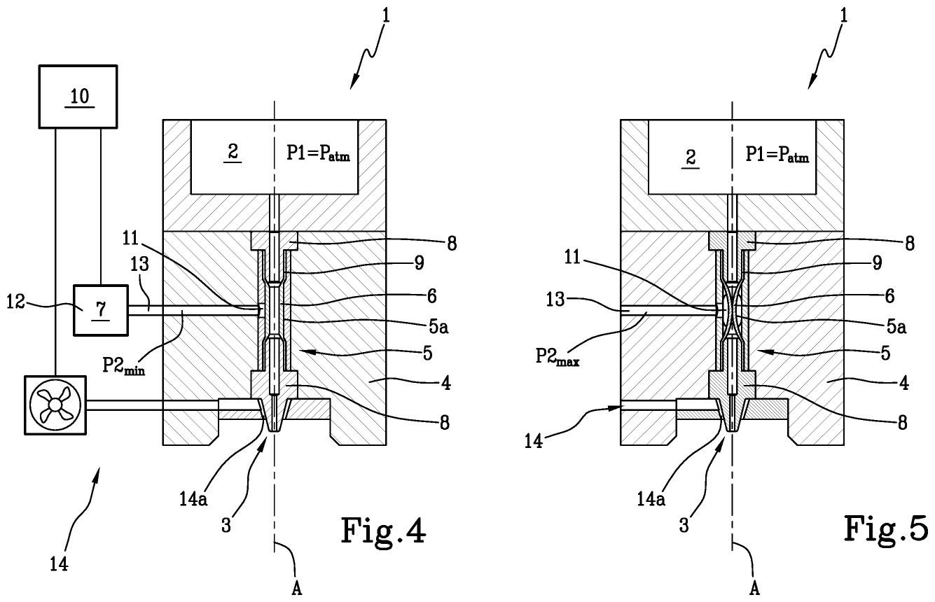

FIGS. 4 and 5 show a second embodiment of the printing device for building material articles according to the present invention, in two different operating states;

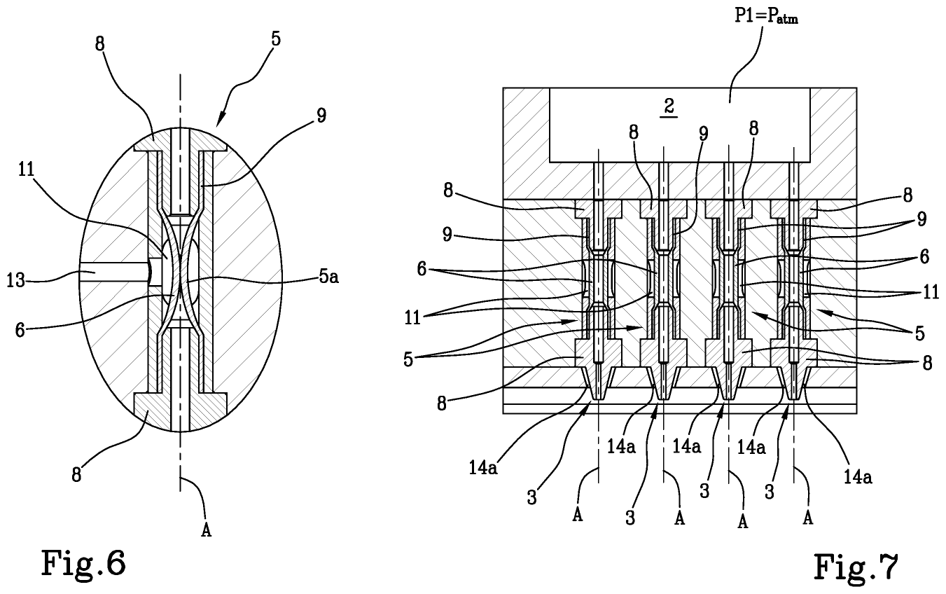

FIG. 6 shows a detail of FIG. 5;

FIG. 7 shows a variation of the device in FIG. 4.

With reference to the appended figures, number 1 indicates a printing device (or head) for building material articles, preferably but not exclusively tiles or ceramic slabs, according to the present invention.

The printing device 1 (or head) is therefore preferably used within a more complete printing machine 100 for building material articles.

The machine (and therefore the device 1) is thus used for printing, coloring and decorating slab-shaped elements, such as, for example articles in cement, roof tiles, tiles etc. by means of using special enamels or powders.

For example, possible workings are of the screen-printing type or the creation of “structures”.

In fact, note that as the device 1 according to the present invention can be adapted to various granulometries of the solid particles, it can be used not only for printing and designing slabs, which are already formed, but also for dispensing the granular material, which will form the slab with a predetermined design (thus upstream of the pressing).

In fact, the enamels or powders, which can be used with the printing device according to the present invention, present a granulometry, which can reach 1 mm for enamels (value 20 times higher than the maximum reachable with known printing devices) and even 50 mm for powders. Therefore, the printing machine comprises a frame and at least one work plane.

Such plane can be used for resting the articles, with the face to be worked (i.e. coloring) facing away from the plane, or as a base for receiving the powders dispensed by the device 1.

The plane can therefore be fixed or movable along a sliding direction.

A printing rod is associated with such frame suitable for achieving the coloring.

The rod extends along its own main direction, facing said plane. Consequently, the rod is made like a portal and surmounts the plane facing it.

Movement means are also preferably associated with the rod, configured to move it along a direction transverse to said main direction.

According to one aspect of the present invention, the machine is provided with one or more printing devices 1 connected to the rod.

Note that, in some embodiments, the plane is movable along a sliding direction the rod comprising a plurality of printing devices (fixed with respect to the rod) distributed along its length to cover a width of said plane.

Alternatively, there could be fewer devices (also one) movable along said rod.

Describing in further detail the device or head 1, the primary object of the present invention, it comprises a tank 2 for a printing material, solid or liquid, to be dispensed and an outlet mouth 3 suitable for dispensing the printing material onto a work surface (i.e. onto the work plane).

In this respect, the device preferably comprises a main body 4 (not necessarily monolithic) on which both the tank 2 and the outlet mouth 3 are obtained or installed.

The device 1 preferably also comprises at least one conduit 5 extending along its own main direction “A” between the tank 2 and the outlet mouth 3.

Therefore, the conduit 5 extends between two end portions connected (or defining) the outlet mouth 3 and a tank 2 entrance respectively.

Such conduit 5 is thus suitable for transferring the printing material from the tank 2 to said outlet mouth 3.

The tank 2, in use, is preferably set at a greater height with respect to the outlet mouth 3.

Therefore, the main direction of the conduit 5 presents at least one vertical component.

In the preferred embodiment, the conduit 5 is substantially vertical. More preferably, such conduit 5 is substantially rectilinear.

The conduit 5 is also preferably obtained in the base body 4.

In some embodiments, a single conduit 5 could be associated with a single base body 4, or a plurality arranged in sequence (in parallel), as for example in FIGS. 3 and 7.

In such embodiments, each conduit 5 reaches its own independent outlet mouth 3, but they all preferably draw the material from one single tank 2. Note that in the embodiments for “fluid” printing material, the outlet mouth 3 is preferably an actual dispensing nozzle.

On the contrary, in the embodiments for solid printing material (i.e. powders), the outlet mouth 3 might simply be a terminal end of the conduit 5.

According to one aspect of the present invention, such conduit 5 comprises at least one wall deformable at least in part 6, movable between an operating position, in which it determines the creation of a restriction in the conduit 5 preventing the flow of the printing material towards the outlet mouth 3 (FIGS. 2 and 5), and a rest position, in which it allows the flow of the printing material towards the outlet mouth 3 (FIGS. 1 and 4). Therefore, in the operating position, the deformable wall 6 abuts against a stop element or counterpart of the same wall closing the passage of the material.

Whereas, in the rest position, the deformable wall 5 is preferably aligned with the conduit portions immediately adjacent thereto, so as not to define an obstacle to the flow of the material.

The deformable wall 6 is therefore preferably oriented along a direction tangential to the main direction “A” of extension of the conduit 5.

Such deformable wall 6 is preferably made of elastically deformable material, more preferably rubber.

In the preferred embodiment, the deformable wall 6 presents a thickness greater than the size of the solid particles contained in the printing material so as to lengthen the useful life of the system.

With reference to the illustrated embodiments, the conduit 5 comprises at least one tubular portion 5a radially deformable defining the deformable wall 6.

Therefore, the operating and rest positions of the deformable wall 6 correspond respectively to a radially contracted condition and a radially expanded condition of the tubular portion 5a.

In other words, in the operating position, two opposite parts of the tubular portion 5a mutually advance until they come into contact, closing the conduit 5.

In the preferred embodiment, the conduit 5 is formed (at least in part) of two tubular joints 8, or tubular connections, which are aligned with each other and spaced along the main direction “A” of the conduit 5.

Such joints 8 are preferably facing each other and opposite, each provided with a connection portion proximal to the other joint and a distal operating portion.

The operating portions define the outlet mouth 3 and the entrance of the tank 2 respectively.

The two joints 8 are joined by means of an elastic tubular sheath 9 interposed and fitted onto the same joints 8, in particular onto the connection portions.

At least part of the sheath 9 thus defines the deformable wall 6. Consequently, the joints 8 define the end portions of the conduit, while the median portion of the sheath 9 (i.e. the one not fitted onto the joints) defines the portion 5a described above.

In order to move the wall 6 between the two aforesaid positions, the device 1 comprises a movement unit 7 arranged outside the conduit 5, associated with the deformable wall 6.

More specifically, inside, the tank 2 presents a predetermined first pressure P1, while the movement unit 7 is configured to generate a second pressure P2 on the deformable wall 6, outside the conduit 5.

The difference between the first pressure P1 and the second pressure P2 determines the position of the deformable wall 6.

In this respect, a control unit 10 is comprised, configured to drive at least one of said first pressure P1 and second pressure P2 for selectively moving the deformable wall 6 between the operating position, in which the second pressure P2 is higher than the first pressure P1, and the rest position, in which the second pressure P2 is lower than the first pressure P1.

The movement unit 7 is preferably configured to vary the second pressure P2 according to a signal received from the control unit 10, in other words according to a signal representative of a design to be produced.

Therefore, the movement unit 7 is configured to generate a second pressure P2 on the deformable wall 6, outside the conduit 5, varying between at least a minimum value P2ₘᵢₙ, lower than the first pressure P1 to keep the deformable wall 6 in the rest position, and at least a maximum value P2ₘₐₓ, higher than the first pressure P1 to bring the deformable wall 6 into the operating position.

The movement unit preferably comprises at least one containment chamber 11 inside which the deformable wall 6 is placed.

The containment chamber 11 is preferably delimited, at least in part, by the deformable wall 6, in other words by a face of the deformable wall outside the conduit 5.

Therefore, on varying the pressure inside the containment chamber 11, the only (elastically) pliable element is the deformable wall 6, which is consequently deformed between the two limit positions.

In this respect, an operating fluid is present in the containment chamber 11.

The movement unit 7 thus comprises a driving member 12 for the operating fluid configured to vary its pressure between at least said minimum value P2ₘᵢₙ and said maximum value P2ₘₐₓ of the second pressure P2. Such driving member 12 is preferably a valve, more preferably a solenoid valve.

The control unit 10 is thus configured to control the driving member 12 according to the design to be produced on the article.

Note that the driving member 12 is of the adjustable type, in other words it can be driven between a series of pressure values, continuous or discrete, between the minimum value and the maximum value.

Consequently, the control unit 10 is programmed to control the driving member 12 so as to impart a plurality of values between said maximum value and said minimum value in order to reduce the opening of the deformable wall 6.

Advantageously, in this way, it is not only possible to vary the conformation of the printed line, but also its thickness.

In order to distance the driving member 12 from the conduit 5, the movement unit 7 comprises at least one fluid transfer tube 13 extending between the driving member 12, distal from the deformable wall 6, and said containment chamber 11, proximal to the deformable wall 6.

Like the conduit 5, the transfer tube 13 is preferably obtained in the base body 4, so as to make the structure constructionally simple and robust. According to a further aspect of the present invention, the device 1 further comprises a cleaning unit placed at said outlet mouth 3, externally thereto, to clean it from possible residues of printing material.

The cleaning unit is preferably a blowing unit 14.

More specifically, the blowing unit 14 comprises at least one blowing mouth 14a oriented tangentially to the outlet mouth 3.

By “tangentially” we mean that the flow of air supplied by the mouth 14a presents at least one component, preferably dominant, oriented parallel to the flow of the material dispensed by the outlet mouth 3.

Advantageously, in this way it is possible to produce a particularly simple cleaning system, which can also exploit the sources of pressurized air already present in the device 1.

As stated previously, the printing device 1 can be used both for dispensing fluid printing materials (e.g. enamels) and for releasing solid powders.

In the first case, in other words in the embodiments for fluid printing (FIG. 1-3), the tank 2 comprises pressure generating means 15 configured to dispense the fluid printing material into the conduit 5 at the predetermined first pressure P1.

Such pressure generating means 15 are preferably defined by a pump or a pumping system.

Furthermore, it should be noted that the tank 2 preferably presents at least one first opening 2a suitable for allowing it to be filled with the printing material.

Preferably, the tank 2 further comprises a second opening 2b suitable for allowing a continuous flow of the fluid printing material going into and coming out of the tank 2.

More specifically, such openings 2a, 2b are placed in connection with the pump/pumping system, in other words with the container, associated with the printing machine.

Advantageously, this guarantees a continuous movement of the enamel, avoiding sedimentation or incrustations due to the depositing of the solid particles in the tank 2 and/or in the conduit 5.

In the preferred embodiment, the tank 2 comprises a compensation member 16 configured to keep the pressure in the tank 2 equal to said predetermined first pressure P1 when the deformable wall 6 of the conduit 5 is in said operating position.

The compensation member 16 is also configured to keep the pressure in the tank 2 equal to said predetermined first pressure P1 when the deformable wall 6 of the conduit 5 is in said rest position.

More preferably, the compensation member 16 is configured to keep the pressure in the tank 2 equal to said predetermined first pressure P1 in all conditions of the deformable wall 6, compensating both overpressure and depressions in the tank.

In other words, the compensation member 16 is configured to absorb the increase in pressure, which is created in the tank 2 when the deformable wall goes from the rest position to the operating position, allowing the balance of pressures between the inside and outside of the walls of the tank 2.

The compensation member 16 preferably comprises a deformable membrane 16a arranged in the tank so as to divide it into two chambers, an upper chamber 17a containing air and a lower chamber 17b containing the fluid printing material.

The deformable membrane 16a is thus the compensation element capable of varying its shape according to the balance of pressures.

For this reason, the compensation member 16 also comprises an actuator assembly 18, preferably a pressure regulator 18a, associated with said upper chamber 17a.

The control unit 10 is configured to drive the actuator assembly 18 according to the pressure detected in the tank 2, in particular, in the lower chamber 17b, so as to keep it equal to the first pressure P1.

Alternatively, in the embodiment which dispenses solid printing material (e.g. powders), shown in FIGS. 4-7, the tank 2 can be made with an open configuration, the first pressure P1 being equal to the atmospheric pressure.

The invention achieves the intended objects and comprises important advantages.

In fact, the presence of a “shutter” defined by the deformable wall, oriented tangentially to the material flow direction, allows the problems of the known systems relating to wear and tear and scarce precision to be overcome.

Moreover, the use of a deformable tubular sheath makes the system particularly resistant to wear and tear and easy to use.

1. A printing device for building material articles, comprising:
a tank (2) for a printing material, solid or liquid, to be dispensed;
at least one outlet mouth (3) suitable for dispensing the printing material onto a work surface;
a conduit (5) extending along its own main direction (A) between said tank (2) and said outlet mouth (3) for transferring the printing material from the tank (2) to said outlet mouth (3);
characterized in that said conduit (5) comprises at least one deformable wall (6) movable between an operating position, in which it determines the creation of a restriction in the conduit (5) preventing the flow of the printing material towards the outlet mouth (3), and a rest position, in which it allows the flow of the printing material towards the outlet mouth (3).

2. The printing device according to claim 1, characterized in that it comprises a movement unit (7), arranged outside said conduit (5) and associated with said deformable wall (6) for moving it between the operating position and the rest position.

3. The printing device according to claim 2, characterized in that, inside the tank (2) there is a predetermined first pressure (P1) and the movement unit (7) is configured to generate a second pressure (P2) on the deformable wall (6), outside the conduit (5); said printing device (1) further comprising a control unit (10) configured to drive at least one of said first (P1) and second pressure (P2) with respect to the other for selectively moving said deformable wall (6) between the operating position, in which the second pressure (P2) is higher than the first pressure (P1), and the rest position, in which the second pressure (P2) is lower than the first pressure (P1).

4. The printing device according to claim 3, characterized in that the movement unit (7) is configured to generate a second pressure (P2) on the deformable wall (6), outside the conduit (5), said second pressure (P2) varying between at least a minimum value (P2min). lower than the first pressure (P1) to keep the deformable wall (6) in the rest position, and at least a maximum value (P2ₘₐₓ), higher than the first pressure (P1) to bring the deformable wall (6) into the operating position.

5. The printing device according to claim 2, characterized in that said movement unit (7) comprises:
at least one containment chamber (11) inside which the deformable wall (6) is placed, containing an operating fluid;
a driving member (12) for said operating fluid configured to vary its pressure between at least a minimum value (P2ₘᵢₙ), in which it keeps the deformable wall (6) in the rest position, and at least a maximum value (P2ₘₐₓ), in which it brings the deformable wall (6) into the operating position.

6. The printing device according to claim 5, characterized in that it comprises a control unit (10) configured to control the driving member (12) according to a design to be produced on the building material article.

7. The printing device according to claim 6, characterized in that said control unit (10) is configured to control the driving member (12) so as to impart a plurality of values between said maximum value (P2ₘₐₓ) and said minimum value (P2ₘᵢₙ) in order to reduce the opening of the deformable wall to vary the thickness of the printed line.

8. The printing device according to claim 5, characterized in that the movement unit (7) comprises at least one fluid transfer tube (13) extending between said driving member (12), distal from the deformable wall (6), and said containment chamber (11), proximal to the deformable wall (6).

9. The printing device according to claim 5, characterized in that said operating fluid is air and said driving member (12) is a valve.

10. The printing device according to claim 1, characterized in that said deformable wall (6) is oriented along a direction tangential to said main direction (A) of development of the conduit (5).

11. The printing device according to claim 1, characterized in that said deformable wall (6) is made of elastically deformable material, preferably rubber.

12. The printing device according to claim 1, characterized in that said conduit (5) comprises at least one tubular portion (5a), which is radially deformable, defining said deformable wall (6), in which the operating and rest positions of the deformable wall (6) correspond respectively to a radially contracted condition and to a radially expanded condition of the tubular portion (5a).

13. The printing device according to claim 1, characterized in that the conduit (5) comprises two tubular joints (8), aligned with each other and spaced along the main direction (A) of the conduit (5) and an elastic tubular sheath (9) interposed between said tubular joints (8) and fitted thereon; said tubular sheath (9) defining said deformable wall (6).

14. The printing device according to claim 1, comprising a blowing unit (14) placed at said outlet mouth (3), externally thereto, to clean it from possible residues of printing material.

15. The printing device according to claim 14, characterized in that said blowing unit (14) comprises at least one blowing mouth (14a) oriented tangentially to the outlet mouth (3).

16. The printing device according to claim 1, characterized in that said tank (2) comprises pressure generating means (15) configured to dispense the fluid printing material into the conduit (5) at a predetermined first pressure (P1).

17. The printing device according to claim 16, characterized in that said tank (2) comprises a compensation member (16) configured to keep the pressure in the tank (2) equal to said predetermined first pressure (P1) when the deformable wall (6) of the conduit (5) is in said operating position.

18. The printing device according to claim 16, characterized in that said tank (2) comprises a compensation member (16) configured to keep the pressure in the tank (2) equal to said predetermined first pressure (P1) when the deformable wall (6) of the conduit (5) is in said rest position.

19. The printing device according to claim 17, characterized in that said compensation member (16) comprises:
a deformable membrane (16a) arranged in the tank so as to divide it into two chambers, an upper chamber (17a) containing air and a lower chamber (17b) containing the fluid printing material;
an actuator assembly (18), preferably a pressure regulator (18a), associated with said upper chamber (17a).

20. The printing device according to claim 1, characterized in that said tank (2) has at least a first opening (2a) and at least a second opening (2b), both suitable for allowing a continuous flow of fluid printing material into and out of the tank (2).

21. A printing machine for building material articles, comprising:
a frame;
at least one plane fixed or movable along a sliding direction;
a rod extending along its own main direction and facing said plane;
at least one printing device (1) according to claim 1 associated with said rod.
